(19) United States
(12) Patent Application Publication
(10) Pub. No.: US 2025/0097319 A1
(43) Pub. Date: Mar. 20, 2025

(54) Connection Switching Server and Connection Switching Method

(71) Applicant: Hitachi Industry & Control Solutions, Ltd, Tokyo (JP)

(72) Inventors: Nobuo TAKAHASHI, Tokyo (JP); Yasuo Sekine, Tokyo (JP)

(21) Appl. No.: 18/818,143

(22) Filed: Aug. 28, 2024

(30) Foreign Application Priority Data
Sep. 19, 2023 (JP) 2023-150772

(51) Int. Cl. H04L 67/60

(52) U.S. Cl. CPC H04L 67/60

(57) ABSTRACT

A connection switching server includes: a service request reception part configured to receive a service request including activation identification information indicating a right to use a service; a connection destination determination part configured to reference an activation information database in which the activation identification information and connection information for connecting to a service that processes the service request are stored and associated with each other, to retrieve connection information for the service request; and a connection destination switching part configured to transmit the service request to a server providing the service corresponding to the connection information.

### CROSS REFERENCE TO RELATED APPLICATIONS

This application claims foreign priority to Japanese Patent Application No. 2023-150772, filed Sep. 19, 2023, the disclosure of which is incorporated herein by reference in its entirety.

### TECHNICAL FIELD OF THE INVENTION

The present invention relates to a connection switching server and a connection switching method for switching a connection to a service that supports a service request from a terminal.

### BACKGROUND

Examples of service provisioning via the Internet include many cases where an organization (company, department, etc., hereinafter referred to as “tenant”) holds a contract with a service provider and multiple users belonging to that tenant use the service. It is a general practice for a user to perform activation (see Japanese Patent Publication No. 2017-175228) before starting the use of the service in order to prevent the number of service users from exceeding the number of users for which the contract has been made.

### SUMMARY

In many cases of service provisioning via the Internet, a plurality of users share the same server or system to use. It is desired that users belonging to the same tenant be allowed to use the same service. It is also desired that users belonging to different tenants be each allowed to use the service provided for the respective tenant even when the users access the same server or system. However, the information processing device described in Japanese Patent Publication No. 2017-175228 has no feature relevant to switching services according to the tenants.

The present invention has been made in view of the background and it is an object of the present invention to provide a connection switching server and a connection switching method for switching services to use, according to activations.

### Solutions

An aspect of the present invention is a connection switching server implemented using one or more hardware processers and including: a service request reception part configured to receive a service request including activation identification information indicating a right to use a service; a connection destination determination part configured to reference an activation information database in which the activation identification information and connection information for connecting to a service that processes the service request are stored and associated with each other, to retrieve the connection information for the service request; a connection destination switching part configured to transmit the service request to a server providing the service corresponding to the connection information; and an activation reception part configured to receive an activation request transmitted by a terminal, the terminal being a transmission source of the service request, the activation request transmitted by the terminal before transmitting an initial service request, the activation request including the activation identification information and tenant identification information indicating a tenant to which the terminal belongs, reference a tenant information database storing and associating the tenant identification information and the connection information with each other, and store and associate the activation identification information and the connection information with each other in the activation information database.

Another aspect of the present invention is a connection switching server implemented using one or more hardware processers and including: a service request reception part configured to receive a service request including activation identification information indicating a right to use a service; a connection destination determination part configured to reference an activation information database in which the activation identification information and connection information for connecting to a service that processes the service request are stored and associated with each other, to retrieve the connection information for the service request; a connection destination switching part configured to transmit the service request to a server providing the service corresponding to the connection information, wherein the service is a retrieval service of retrieval from a database, and wherein the connection information includes: an address of a database management server including the database; and identification information identifying the database.

According to the present invention, it is possible to provide a connection switching server and a connection switching method for switching services to use, according to activations. Problems to be solved, configurations, and effects, other than those described above, will become clear by the descriptions of the embodiments given below.

### BRIEF DESCRIPTION OF THE DRAWINGS

FIG. 1 is a configuration diagram of a service provisioning system according to a first embodiment.

FIG. 2 is a function block diagram of a terminal according to the first embodiment.

FIG. 3 is a function block diagram of a connection switching server according to the first embodiment.

FIG. 4 is a data structure diagram of a tenant information database according to the first embodiment.

FIG. 5 is a data structure diagram of an activation information database according to the first embodiment.

FIG. 6 is a sequence diagram of activation processing according to the first embodiment.

FIG. 7 is a sequence diagram of business operation processing according to the first embodiment.

FIG. 8 is a function block diagram of a connection switching server according to a second embodiment.

FIG. 9 is a sequence diagram of business operation processing according to the second embodiment.

FIG. 10 is a hardware configuration diagram applicable to the connection switching servers, database management servers, and terminals, according to the first and second embodiments.

### DETAILED DESCRIPTION OF EMBODIMENT

Hereinafter, a description will be given of a service provisioning system in a mode (embodiment) for carrying out the present invention. The service provisioning system includes: a database management server that provides a database management service; and a connection switching server that accepts service requests from terminals. The services provided by the service provisioning system to terminals include retrieval services of databases. The database management server includes one or more databases and provides services for utilizing a distinct database per tenant (organization) owning terminals.

Prior to the use of a service, a terminal and the connection switching server perform activation processing to share activation identification information. The terminal transmits a service request including the activation identification information to the connection switching server. The connection switching server switches the database to be connected according to the activation identification information.

By using such a service provisioning system, the user of the terminal, after performing activation processing confirming that the user or the terminal belongs to the tenant, is allowed to use the service provided for the tenant.

### First Embodiment—Configuration of Service Provisioning System

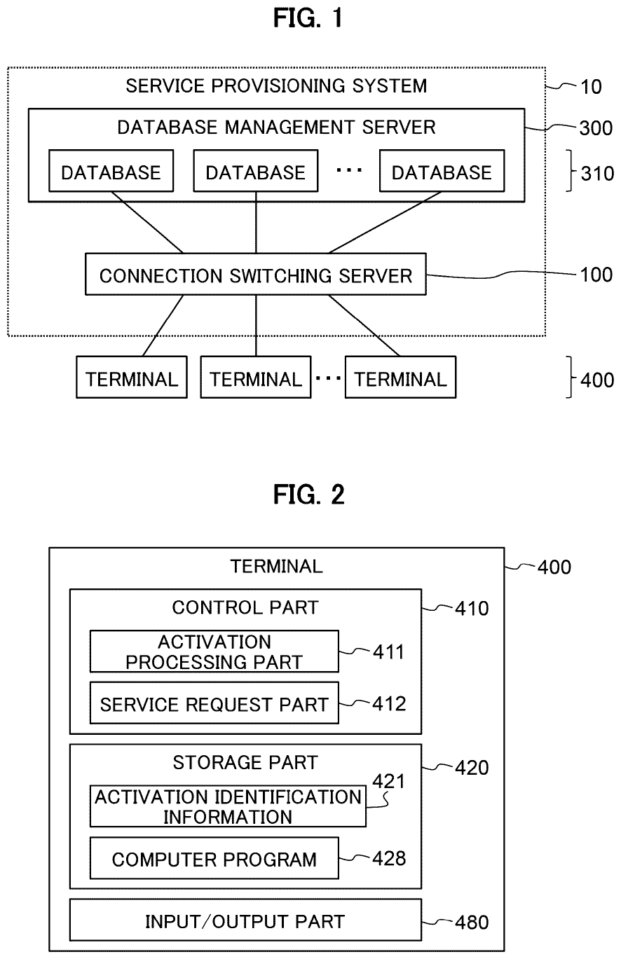

FIG. 1 is a configuration diagram of a service provisioning system 10 according to a first embodiment. The service provisioning system 10 includes: a connection switching server 100 and a database management server 300. The database management server 300 includes a plurality of databases 310 and provides services for utilizing the databases 310 individually.

A terminal 400 uses a database 310 via the connection switching server 100. The terminal 400 belongs to a company or to a tenant that is a department of the company. The tenant holds a contract with a provider that owns the service provisioning system 10 and provides a database management service, to use the database 310. The terminal 400, owned by (belonging to) the tenant, uses the database 310 the tenant has contracted to use.

### First Embodiment—Configuration of Terminal

FIG. 2 is a function block diagram of a terminal 400 according to a first embodiment. The terminal 400 is a computer including a control part 410, a storage part 420, and an input/output part 480. Examples of devices connected to the input/output part 480 include user interface devices such as a display monitor, a keyboard, and a mouse. The input/output part 480 includes a communication device that allows to transmit/receive data to/from the connection switching server 100 via a network.

### Terminal—Storage Part

The storage part 420 is configured including storage devices such as a Read Only Memory (ROM), a Random Access Memory (RAM), and a Solid State Drive (SSD). Information stored in the storage part 420 includes activation identification information 421 and a computer program 428.

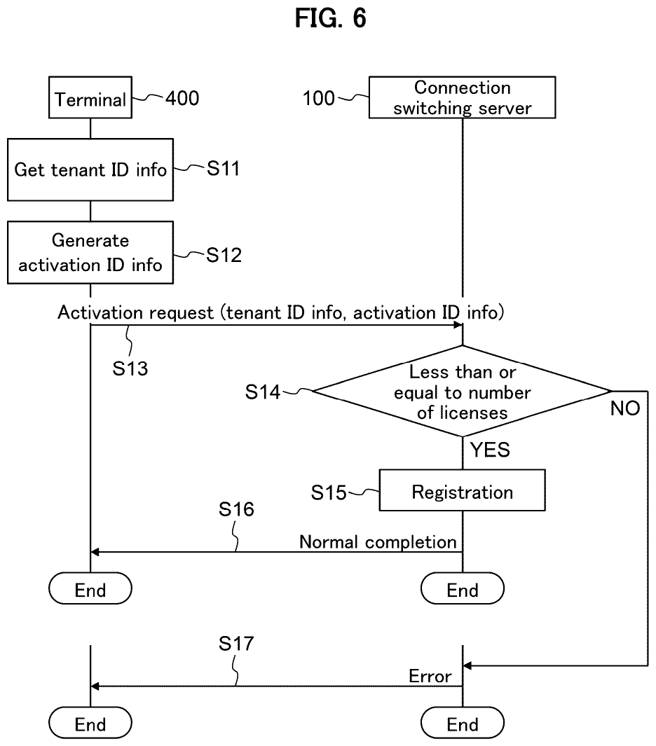

The activation identification information 421 is identification information generated in activation processing (see later-described FIG. 6) and is referenced to identify the database 310 to be used by the terminal 400. The activation identification information 421 differs per terminal 400. The activation identification information is information that indicates the right of the terminal 400 to use the retrieval service using the database 310. The retrieval service is to be provided by the service provisioning system 10 according to the contract signed by the tenant.

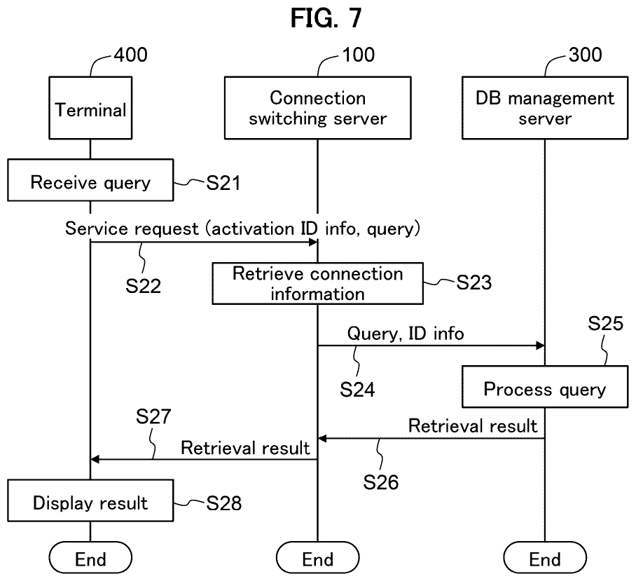

The computer program 428 includes instructions for the processing by the terminal 400 to perform the activation processing (see later-described FIG. 6) and the business operation processing (see later-described FIG. 7).

### Terminal—Control Part

The control part 410 is configured with a Central Processing Unit (CPU) and includes an activation processing part 411 and a service request part 412.

The activation processing part 411 performs the processing of the terminal 400 to perform the activation processing (see later-described FIG. 6).

The service request part 412 performs the processing of the terminal 400 to perform business operation processing (see later-described FIG. 7).

### First Embodiment—Configuration of Connection Switching Server

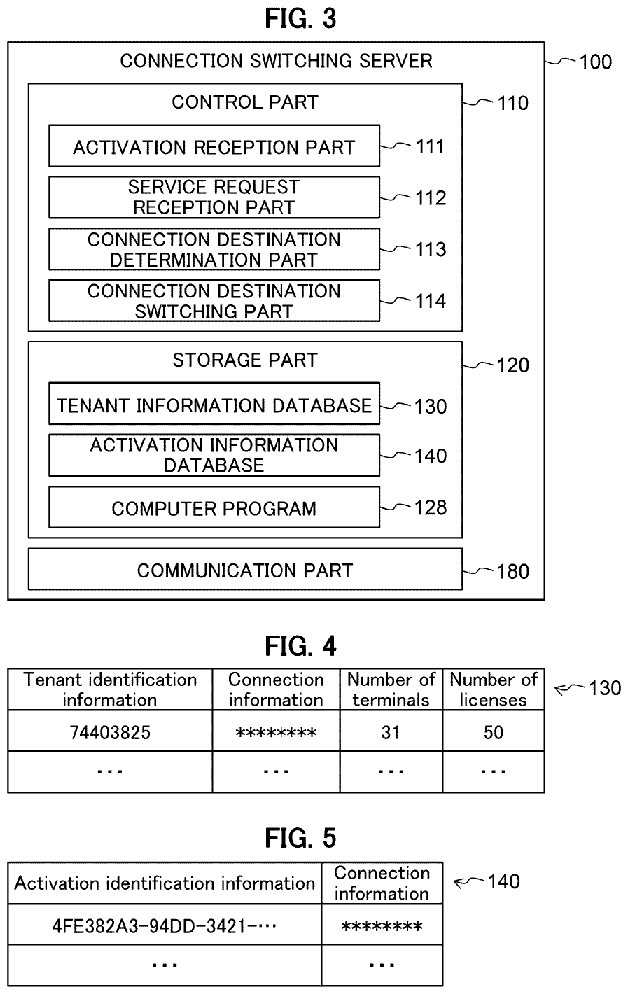

FIG. 3 is a function block diagram of a connection switching server 100 according to the first embodiment. The connection switching server 100 is a computer including a control part 110, a storage part 120, and a communication part 180. The communication part 180 includes a communication device and is capable of transmitting/receiving data via a network to/from the terminals 400 and the database management server 300.

### Connection Switching Server—Storage Part

The storage part 120 is configured including storage devices such as a ROM, a RAM, and an SSD. The storage part 120 stores a tenant information database 130, an activation information database 140, and a computer program 128. The computer program 128 includes instructions for the processing by the connection switching server 100 to perform the activation processing (see later-described FIG. 6) and the business operation processing (see later-described FIG. 7).

### Storage Part—Tenant Information Database

FIG. 4 is a data structure diagram of the tenant information database 130 according to the first embodiment. The tenant information database 130 is, for example, table-formatted data in which one row (record) represents a tenant. A record of the tenant information database 130 includes columns (attributes) of: tenant identification information; connection information; number of terminals; and number of licenses.

The tenant identification information is information used to identify the tenant.

The connection information is information for connecting to a database 310 used by the terminals 400 belonging to the tenant. The connection information includes the address of the database management server 300, identification information of the database 310, authentication information to be used in accessing the database 310. The identification information of the database 310 may include, in addition to the name of the database, a schema and the name of a table. In other words, the connection information is information for using the retrieval service using the database 310 and is also information for connecting to the database 310.

The number of terminals is the number of the terminals 400 that belong to the tenant and have completed the later-described activation processing.

The number of licenses is an upper limit on the number of terminals 400 covered by the tenant's contract. The database 310 is available to a number of terminals 400 up to the number of licenses.

As has been described above, the service provided is a retrieval service of retrieval from a database, and the connection information includes the address of the database management server 300 having the database 310 and identification information of the database 310.

### Storage Part—Activation Information Database

FIG. 5 is a data structure diagram of an activation information database 140 according to the first embodiment. The activation information database 140 is, for example, table-formatted data in which one row (record) corresponds to a terminal 400. A record of the activation information database 140 includes columns (attributes) of: activation identification information; and connection information.

The activation identification information is information that identifies the activation of the terminal 400.

The connection information is the connection information corresponding to the tenant to which the terminal 400 belongs, and corresponds to the connection information in the tenant information database 130 (see FIG. 4).

### Connection Switching Server—Control Part

Returning to FIG. 3, a description will be given of the control part 110. The control part 110 is configured with a CPU and includes an activation reception part 111, a service request reception part 112, a connection destination determination part 113, and a connection destination switching part 114.

### Control Part—Activation Reception Part

The activation reception part 111 performs the processing of the connection switching server 100 to perform the activation processing (see later-described FIG. 6). In more detail, the activation reception part 111 confirms that, in response to an activation request transmitted by a terminal 400, the number of the terminals 400 having requested activation does not exceed the number of licenses (see FIG. 4). Next, the activation reception part 111 registers, in the activation information database 140 (see FIG. 5), activation identification information included in the activation request and connection information corresponding to the tenant identification information. Note that the connection information corresponding to the tenant identification information is retrievable by referencing the tenant information database 130 (see FIG. 4).

### Control Part—Service Request Reception Part

The service request reception part 112 receives from a terminal 400 a service request, which is a request for accessing the database 310 The service request includes the activation identification information of the terminal 400.

### Control Part—Connection Destination Determination Part

The connection destination determination part 113 retrieves connection information for connecting to the database 310 according to the service request. In more detail, the connection destination determination part 113 references the activation information database 140 (see FIG. 5) based on the activation identification information included in the service request to retrieve the connection information corresponding to the database 310.

### Control Part—Connection Destination Switching Part

The connection destination switching part 114 transfers the service request to the database management server 300 to receive the retrieval result of the database 310. Next, the connection destination switching part 114 transfers the retrieval result to the terminal 400.

As has been described above, the connection switching server 100 includes the service request reception part 112, which receives a service request including activation identification information that indicates the right to use the service.

The connection switching server 100 further includes the connection destination determination part 113, configured to retrieve the connection information of the service request by referencing the activation information database 140 (see FIG. 5) in which the activation identification information and the connection information for connecting to the service that processes the service request are stored and associated with each other.

The connection switching server 100 further includes the connection destination switching part 114, configured to transfer the service request to a server providing the service corresponding to the connection information.

The connection switching server 100 further includes the activation reception part 111. The activation reception part 111 is configured to receive an activation request transmitted by a terminal 400, which is a transmission source of service requests. The activation request is transmitted by the terminal 400 before transmitting an initial service request and includes the activation identification information and tenant identification information indicating the tenant to which the terminal 400 belongs. The activation reception part 111 is further configured to reference the tenant information database 130 (see FIG. 4) in which the tenant identification information and the connection information are stored and associated with each other and to store and associate the activation identification information and the connection information with each other in the activation information database 140.

### First Embodiment—Database Management Server

The database management server 300 performs retrieval processing in response to a query (retrieval request), a service request transmitted by the connection switching server 100, and returns the retrieval result. In more detail, the connection switching server 100 transmits to the address of the database management server 300, which is included in the connection information, a service request including the identification information on the database 310 and a query. The database management server 300 executes the query on the database 310 identified by the identification information and returns the retrieval result.

### First Embodiment—Activation Processing

FIG. 6 is a sequence diagram of activation processing according to the first embodiment. Here, it is assumed that, at the time of starting the activation processing, a tenant owning terminals 400 and a provider providing a database management service have established a contract and that a record of the tenant has been registered in the tenant information database 130 (see FIG. 4). It is also assumed that tenant identification information is delivered to the users of the terminals 400; that the servicing by the database 310 corresponding to the tenant is in a state of being available; that a secure communication path has already been established between a terminal 400 and the connection switching server 100; and that there is no eavesdropping or spoofing of communication data.

In Step S11, the activation processing part 411 of the terminal 400 gets the tenant identification information inputted by the user of the terminal 400.

In Step S12, the activation processing part 411 generates activation identification information, which is a random number, and embeds it into the activation identification information 421 (see FIG. 2)

In Step S13, the activation processing part 411 transmits to the connection switching server 100 an activation request including the tenant identification information and the activation identification information.

In Step S14, the activation reception part 111 of the connection switching server 100 determines whether the number of the terminals 400 having transmitted activation requests is less than or equal to the number of licenses (see FIG. 4). The number of the terminals 400 that have transmitted activation requests in the past is indicated in the column of number of terminals (see FIG. 4). When the number resulted in adding 1 to the number of terminals is less than or equal to the number of licenses (Step S14: YES), the activation reception part 111 advances the processing to Step S15; and when the number resulted in adding 1 to the number of terminals exceeds the number of licenses (Step S14: NO), the activation reception part 111 advances the processing to Step S17.

In Step S15, the activation reception part 111 registers and associates the activation identification information and the connection information corresponding to the tenant identification information with each other in the activation information database 140 (see FIG. 5). In more detail, the activation reception part 111 references the tenant information database 130 (see FIG. 4) to retrieve the connection information corresponding to the tenant identification information. Next, the activation reception part 111 registers and associates the activation identification information and the retrieved connection information with each other in the activation information database 140. Further, the activation reception part 111 increases the number of terminals in the tenant information database 130 by 1.

In Step S16, the activation reception part 111 notifies the terminal 400 that the activation request has been completed normally.

In Step S17, the activation reception part 111 notifies the terminal 400 that an error has occurred in processing the activation request.

### Business Operation Processing

FIG. 7 is a sequence diagram of business operation processing according to the first embodiment. It is assumed that at the time of starting the business operation processing, the activation processing (see FIG. 6) for the terminal 400 has been completed; that a secure communication path has already been established between the terminal 400 and the connection switching server 100; and that there is no eavesdropping or spoofing of communication data.

In Step S21, the service request part 412 of the terminal 400 receives from the user a query (retrieval request) to the database 310.

In Step S22, the service request part 412 transmits a service request including the activation identification information and the query to the connection switching server 100. The service request reception part 112 of the connection switching server 100 receives the service request.

In Step S23, based on the activation identification information included in the service request, the connection destination determination part 113 of the connection switching server 100 references the activation information database 140 (see FIG. 5) to retrieve connection information. Note that when the activation identification information has not been registered in the activation information database 140, the connection destination determination part 113 notifies the terminal 400 of an error and terminates the business operation processing.

In Step S24, the connection destination switching part 114 of the connection switching server 100 references the retrieved connection information and transmits: the query; and identification information included in the retrieved connection information and identifying the database 310, to the database management server 300. If the retrieved connection information include authentication information, the connection destination switching part 114 transmits the authentication information as well.

In Step S25, the database management server 300 processes the query using the database 310 to get a retrieval result.

In Step S26, the database management server 300 transmits the retrieval result to the connection switching server 100.

In Step S27, the connection destination switching part 114 of the connection switching server 100 transmits the retrieval result to the terminal 400.

In Step S28, the service request part 412 of the terminal 400 displays the retrieval result on a display monitor connected to the input/output part 480.

### First Embodiment—Features of Connection Switching Server

The connection switching server 100 receives an activation request from a terminal 400 and registers the activation identification information in the activation information database 140. Note that the number of terminals 400 that can be registered has an upper limit (see column of the number of licenses in the tenant information database 130 illustrated in FIG. 4)

The connection switching server 100 receives a service request (query) from the terminal 400, and, based on the connection information corresponding to the tenant to which the terminal 400 belongs, transfers the query to the database management server 300, and obtains the retrieval result, and replies the retrieval result to the terminal 400. This retrieval result is a result of retrieval processing using the database 310 identified by identification information included in the connection information.

With the use of such connection switching server 100, the user of the terminal 400, after performing activation processing to confirm that the user or the terminal 400 belongs to a tenant, becomes able to use the retrieval service using the database 310 for the tenant. The terminals 400 of different tenants communicate with the same connection switching server 100 but the database 310 to be used differs per tenant.

The provider providing the service provisioning system 10 is not required to prepare servers (connection switching server 100 and/or database management server 300) per tenant and thus is able to provide the service with low cost.

### Modification Example—Activation Information Database

In the case of the above-described embodiment, the activation information database 140 (FIG. 5) stores data associating the activation identification information and the connection information with each other. But the activation information database 140 is not limited to this. An activation information database may store data associating the activation identification information and the tenant identification information with each other. In this case, the connection destination determination part 113 references the activation information database to retrieve tenant identification information corresponding to the activation identification information and further references the tenant information database 130 (see FIG. 4) to retrieve connection information corresponding to the tenant identification information. Note that in this case, the activation reception part 111 registers and associates (see Step S15 illustrated in FIG. 6) the activation identification information and the tenant identification information with each other in the activation information database.

### Modification Example—Activation Processing

In the case of the above-described embodiment, the activation identification information is generated by the terminal 400 and transmitted by the terminal 400 to the connection switching server 100 together with the tenant identification information. Instead, the activation reception part 111 may, upon receipt of tenant identification information from a terminal 400, generate activation identification information and transmits the activation identification information to the terminal 400.

### Second Embodiment

In the case of the first embodiment, the retrieval result itself of retrieval from the database 310 is transmitted to the terminal 400 (see steps S25 to S27 illustrated in FIG. 7). A connection switching server may process the retrieval result and transmit the processed result to the terminal 400.

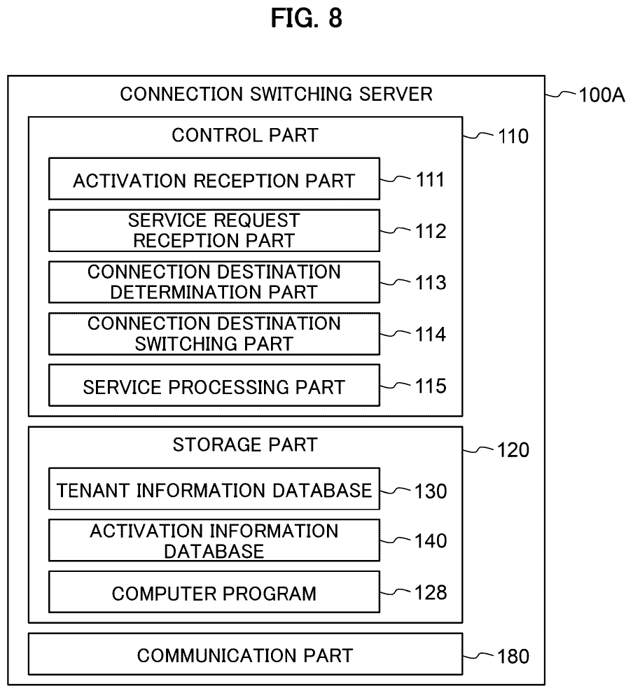

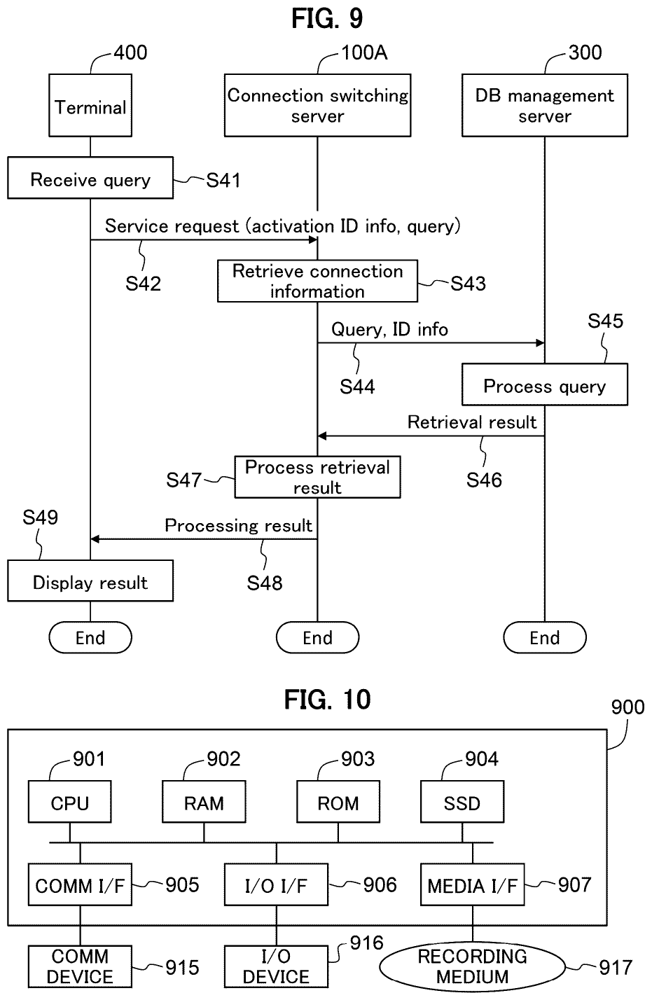

FIG. 8 is a function block diagram of a connection switching server 100A according to a second embodiment. In comparison with the connection switching server 100 (see FIG. 3) according to the first embodiment, the control part 110 further includes a service processing part 115. The service processing part 115 processes the retrieval result and transmits the processed result to the terminal 400. For example, the query (see step S44 illustrated in FIG. 9) may include a plurality of queries, and the service processing part 115 may perform processing of merging a plurality of retrieval results (see Step S46) resulted in executing the plurality of queries and transmit the merged result to the terminal 400 as the processing result (see Step S48).

FIG. 9 is a sequence diagram of business operation processing according to the second embodiment. It is assumed that a secure communication path has already been established between the terminal 400 and the connection switching server 100A; and that there is no eavesdropping or spoofing of communication data.

Steps S41 to S46 are the same as Step S21 to S26

In Step S47, the service processing part 115 processes the retrieval result received from the database management server 300 (e.g., merges a plurality of retrieval results).

In Step S48, the service processing part 115 transmits the result of the processing in Step S47 to the terminal 400.

In Step S49, the service request part 412 displays the processing result on a display monitor connected to the input/output part 480.

### Second Embodiment—Features of Connection Switching Server

The connection switching server 100A performs processing on the retrieval result and transmits the processing result to the terminal 400. In this way, the connection switching server 100A is capable of not merely providing retrieval processing by databases but also providing additional services.

### Modification Example—Services

In the above-described embodiments, the service provisioning system 10 provides services related to databases (retrieval services), but the services to be provided is not limited to this. The database management server 300 may be a server that provides services such as Web meeting, schedule management, Customer Relationship Management (CRM), Enterprise Resource Planning (ERP).

### Other Modification Examples

Although several embodiments of the present invention have been described above, these embodiments are merely illustrative and do not limit the technical scope of the present invention. For example, as a modification example of the first embodiment, the activation information database 140 (see FIG. 5) has been described as storing and associating the activation identification information and the tenant identification information with each other. Additionally, the tenant information database 130 (see FIG. 4) may include a table in which the tenant identification information and the connection information are associated with each other and a table in which the tenant identification information, the number of terminals, and the number of licenses are associated with one another. Like this, the tenant information database 130 and the activation information database 140 may take various data configurations.

The present invention can be carried out in various other embodiments, and various modifications such as omissions and substitutions can be made without departing from the gist of the present invention. These embodiments and modifications thereof are included in the scope and gist of the invention described in the present specification and the like, and are included in the invention described in the claims and an equivalent scope thereof.

### Hardware Configuration

FIG. 10 is a hardware configuration diagram applicable to the connection switching servers 100 and 100A, database management server, and terminals 400, according to the first and second embodiments. The connection switching servers 100 and 100A, the database management server, and terminals 400 may each be configured as a computer 900 including a CPU 901, a RAM 902, a ROM 903, an SSD 904, a communication I/F 905, an input/output I/F 906, and a media I/F 907. Here, “I/F” means an interface.

The communication I/F 905 is connected with an external communication device 915. The input/output I/F 906 is connected with an input/output device(s) 916. The media I/F 907 reads/writes data from/to the recording medium 917. Further, the CPU 901 implements functional parts by executing a computer program (generally called as “application” or “appli” as abbreviation thereof) loaded into the RAM 902. This computer program can be delivered via a communication line or can be recorded in the recording medium 917 such as CD-ROMs to be delivered.

What is claimed is:

1. A connection switching server implemented using one or more hardware processers and comprising:
a service request reception part configured to receive a service request including activation identification information indicating a right to use a service;
a connection destination determination part configured to reference an activation information database in which the activation identification information and connection information for connecting to a service that processes the service request are stored and associated with each other, to retrieve the connection information for the service request;
a connection destination switching part configured to transmit the service request to a server providing the service corresponding to the connection information; and
an activation reception part configured to
receive an activation request transmitted by a terminal, the terminal being a transmission source of the service request, the activation request transmitted by the terminal before transmitting an initial service request, the activation request including the activation identification information and tenant identification information indicating a tenant to which the terminal belongs,
reference a tenant information database storing and associating the tenant identification information and the connection information with each other, and
store and associate the activation identification information and the connection information with each other in the activation information database.

2. A connection switching server implemented using one or more hardware processers and comprising:
a service request reception part configured to receive a service request including activation identification information indicating a right to use a service;
a connection destination determination part configured to reference an activation information database in which the activation identification information and connection information for connecting to a service that processes the service request are stored and associated with each other, to retrieve the connection information for the service request; and
a connection destination switching part configured to transmit the service request to a server providing the service corresponding to the connection information,
wherein the service is a retrieval service of retrieval from a database, and
wherein the connection information includes: an address of a database management server including the database; and identification information identifying the database.

3. A connection switching method for a connection switching server implemented using one or more hardware processers, the connection switching method being performing by the connection switching server and comprising steps of:
receiving a service request including activation identification information indicating a right to use a service;
referencing an activation information database in which the activation identification information and connection information for connecting to a service that processes the service request are stored and associated with each other, to retrieve the connection information for the service request;
transmitting the service request to a server providing the service corresponding to the connection information; and
receiving an activation request transmitted by a terminal, the terminal being a transmission source of the service request, the activation request transmitted by the terminal before transmitting an initial service request, the activation request including the activation identification information and tenant identification information indicating a tenant to which the terminal belongs;
referencing a tenant information database storing and associating the tenant identification information and the connection information with each other; and
storing and associating the activation identification information and the connection information with each other in the activation information database.

4. A connection switching method for a connection switching server implemented using one or more hardware processers, the connection switching method being performing by the connection switching server and comprising steps of:
receiving a service request including activation identification information indicating a right to use a service;
referencing an activation information database in which the activation identification information and connection information for connecting to a service that processes the service request are stored and associated with each other, to retrieve the connection information for the service request; and
transmitting the service request to a server providing the service corresponding to the connection information,
wherein the service is a retrieval service of retrieval from a database, and
wherein the connection information includes: an address of a database management server including the database; and identification information identifying the database.
